(19) United States
(12) Patent Application Publication
(10) Pub. No.: US 2022/0215381 A1
(43) Pub. Date: Jul. 7, 2022

(54) METHODS, SYSTEMS, AND NON-TRANSITORY COMPUTER-READABLE RECORD MEDIA FOR PROMPT TRANSFER OF CRYPTOCURRENCY

(71) Applicant: LINE Corporation, Tokyo (JP)

(72) Inventors: Miyoung JANG, Seongnam-si (KR); Hyun Dong LEE, Seongnam-si (KR); Jaeman KIM, Seongnam-si (KR); Byeong Guk GIM, Seongnam-si (KR); Ji Soo LEE, Seongnam-si (KR); Ui Seok SHIM, Seongnam-si (KR); Dong Young HEO, Seongnam-si (KR); Nara HWANG, Seongnam-si (KR); Dong Hwan KIM, Seongnam-si (KR); Seung Shin KIM, Seongnam-si (KR); Beom Woo MOON, Seongnam-si (KR)

(73) Assignee: LINE Corporation, Tokyo (JP)

(21) Appl. No.: 17/567,337

(22) Filed: Jan. 3, 2022

(30) Foreign Application Priority Data
Jan. 4, 2021 (KR) 10-2021-0000520

(51) Int. Cl. G06Q 20/36; G06Q 20/38; G06Q 20/06

(52) U.S. Cl. CPC G06Q 20/3674; G06Q 20/363; G06Q 20/065; G06Q 20/3825; G06Q 20/38215

(57) ABSTRACT

Disclosed is a method, system, and non-transitory computer-readable record medium for immediate or prompt cryptocurrency trading. A cryptocurrency trading method includes receiving, by at least one processor, a transfer request from a user for a transfer transaction to a second party exchange from a first party exchange, the first party exchange being provided by the computer system, and processing, by the at least one processor, the transfer transaction as an internal transaction in response to the transfer request by using a first party account without using a blockchain network, the first party account being an account of the first party exchange on the second party exchange.

### CROSS-REFERENCE TO RELATED APPLICATION(S)

This U.S. non-provisional application claims the benefit of priority under 35 U.S.C. § 119 to Korean Patent Application No. 10-2021-0000520, filed Jan. 4, 2021, the entire contents of which are incorporated herein by reference in their entirety.

### TECHNICAL FIELD

Some example embodiments relate to technology for rapidly processing cryptocurrency trading.

### BACKGROUND

Currently, with the advent of encryption technology, interest in a cryptocurrency based on encryption technology is significantly increasing.

A representative example of a cryptocurrency includes Bitcoin (BTC). In addition thereto, Ethereum (ETH), Tether (USDT), Litecoin (LTC), and dash are leading the cryptocurrency market.

Unlike the general currency issued by the government or the central bank, such cryptocurrencies are traded according to regulations set by original creators and are being distributed based on blockchain technology.

For example, technology is enabled for trading a cryptocurrency using a private key provided to a uniform resource locator (URL) using a method of authorizing trading through a server configured to verify transaction information of a cryptocurrency having a blockchain, and confirming the trading based on whether the trading is authorized by a verification server.

### SUMMARY

Some example embodiments may provide a cryptocurrency trading service in a structure that allows an immediate transaction between cryptocurrency exchanges.

Some example embodiments may provide rapid processing through an internal transaction algorithm between exchanges instead of a transaction through a blockchain network in response to a transfer request from a user.

According to an aspect of some example embodiments, there is provided a cryptocurrency trading method performed by a computer system, the computer system including at least one processor configured to execute computer-readable instructions stored in a memory, the cryptocurrency trading method including receiving, by at least one processor, a transfer request from a user for a transfer transaction to a second party exchange from a first party exchange, the first party exchange being provided by the computer system, and processing, by the at least one processor, the transfer transaction as an internal transaction in response to the transfer request by using a first party account without using a blockchain network, the first party account being an account of the first party exchange on the second party exchange.

The processing of the transfer transaction may include calling a deposit application programming interface (API) for deposit from the first party account to a recipient wallet address, the recipient wallet address being included in the transfer request.

The processing of the transfer transaction may include setting a lock on a transfer request quantity of assets of the user on the first party exchange, the transfer request quantity being included in the transfer request, performing deposit processing by applying the transfer request quantity from the first party account to a recipient wallet address, the recipient wallet address being included in the transfer request, and moving the locked quantity to a first party balance on the first party exchange.

The processing of the transfer transaction may further include determining a target exchange corresponding to the second party exchange using the recipient wallet address.

The processing of the transfer transaction may include providing the user with a user interface after the first party account is opened on the second party exchange, the user interface enabling selection of a trading scheme option among a plurality of trading scheme options, the plurality of trading scheme options include a first trading scheme using the blockchain network and a second trading scheme using the first party account, and processing the transfer transaction using the first party account based on a selection by the user of the second trading scheme.

The cryptocurrency trading method may further include processing, by the at least one processor, a settlement of the first party account using a settlement transaction through the blockchain network, the settlement corresponding to the transfer transaction.

The processing of the settlement of the first party account may include creating the settlement transaction for withdrawal of a deposit quantity, and submitting the settlement transaction to the blockchain network based on a current balance of the first party account being less than a first balance, and the deposit quantity being deposited to the first party account after the settlement transaction is mined by the blockchain network.

The first balance may be determined based on a trading volume using the first party account for a period.

The first balance may be determined based on an average exchange-by-exchange deposit balance opened on the second party exchange.

The deposit quantity may be determined based on a trading volume using the first party account for a period.

The deposit quantity may be determined based on a difference amount between the current balance and the first balance.

According to an aspect of some example embodiments, there is provided a non-transitory computer-readable record medium storing instructions that, when executed by at least one processor included in a computer system, cause the computer system to perform the cryptocurrency trading method.

According to an aspect of some example embodiments, there is provided a computer system including at least one processor configured to execute computer-readable instructions stored in a memory to process a transfer transaction through an internal transaction using a first party account instead of a transaction using a blockchain network in response to a transfer request, the first party account being an account of a first party exchange on a second party exchange, the transfer request being received from a user for the transfer transaction to the second party exchange from the first party exchange, and the first party exchange being provide by the computer system.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to some example embodiments;

FIG. 2 is a diagram illustrating an example of an electronic device and a server according to some example embodiments;

FIG. 3 illustrates an example of a process of processing a transfer transaction according to some example embodiments;

FIG. 4 is a diagram illustrating an example of a component includable by a processor of a server according to some example embodiments;

FIG. 5 is a flowchart illustrating an example of a method performed by a server according to some example embodiments;

FIG. 6 is a flowchart illustrating an example of an immediate transfer process according to some example embodiments; and

FIG. 7 is a flowchart illustrating an example of a settlement process according to an immediate transfer according to some example embodiments.

### DETAILED DESCRIPTION

Some example embodiments will be described in detail with reference to the accompanying drawings. Some example embodiments, however, may be embodied in various different forms, and should not be construed as being limited to only the illustrated examples. Rather, the illustrated examples are provided so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as, or a similar meaning to, that commonly understood by one of ordinary skill in the art to which some example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned herein. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, some example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of some example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

Some example embodiments relate to technology for rapidly processing a cryptocurrency trade.

Some example embodiments including the disclosures described herein may provide a cryptocurrency trading service in a structure that allows an immediate transaction between cryptocurrency exchanges, and may achieve many advantages in terms of rapidness, efficiency, convenience, cost saving, and the like.

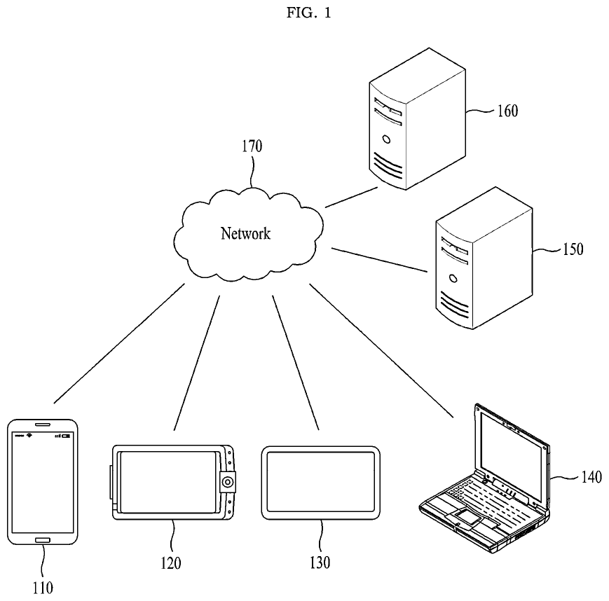

FIG. 1 illustrates an example of a network environment according to some example embodiments. Referring to FIG. 1, the network environment may include a plurality of electronic devices 110, 120, 130, and/or 140, a plurality of servers 150 and/or 160, and a network 170. FIG. 1 is provided as an example only. The number of electronic devices, and/or the number of servers, in the network environment is not limited thereto.

Each of the plurality of electronic devices 110, 120, 130, and/or 140 may be a fixed terminal or a mobile terminal that is configured as a computer system. For example, the plurality of electronic devices 110, 120, 130, and/or 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and/or the like. For example, although FIG. 1 illustrates a shape of a smartphone as an example of the electronic device 110, the electronic device 110 used herein may refer to one of various types of physical computer apparatuses capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and/or Internet. Also, the network 170 may include at least one of network topologies that include a bus network, a star network, a ring network, a mesh network, a star-bus network, a tree or hierarchical network, and/or the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and/or 140 over the network 170. For example, the server 150 may be a system that provides a first service to the plurality of electronic devices 110, 120, 130, and/or 140 connected over the network 170. The server 160 may be a system that provides a second service to the plurality of electronic devices 110, 120, 130, and/or 140 connected over the network 170. In detail, the server 150 may provide, as the first service, a service (e.g., a cryptocurrency trading service) intended (e.g., requested and/or received) by an application through the application as a computer program installed and running on the plurality of electronic devices 110, 120, 130, and/or 140. As another example, the server 160 may provide, as the second service, a service that distributes a file for installing and executing the application to the plurality of electronic devices 110, 120, 130, and/or 140.

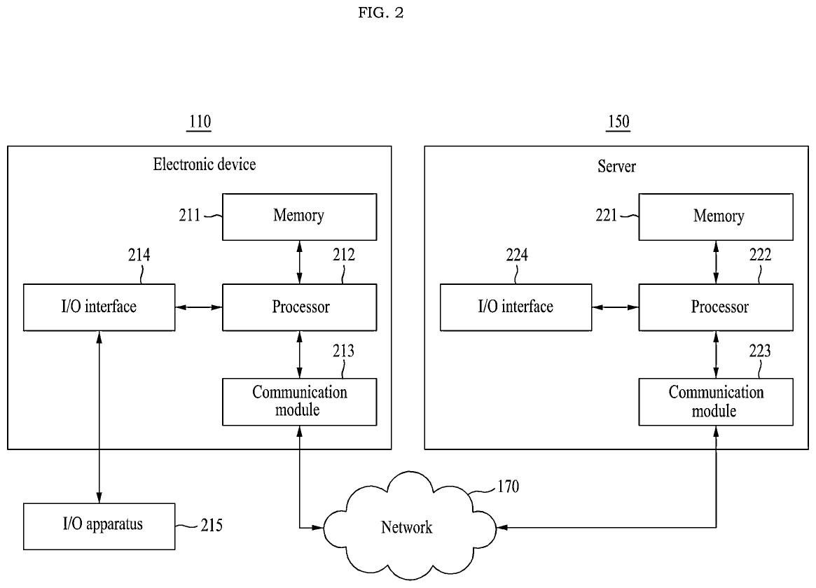

FIG. 2 is a block diagram illustrating an example of an electronic device and a server according to some example embodiments. Description is made using the electronic device 110 as an example of an electronic device and the server 150 as an example of a server with reference to FIG. 2. Also, each of the other electronic devices 120, 130, and/or 140, and/or the server 160, may have the same configuration as (or a similar configuration to) that of the electronic device 110 or the server 150.

Referring to FIG. 2, the electronic device 110 may include a memory 211, processing circuitry (e.g., a processor 212), a communication module 213, and/or an input/output (I/O) interface 214, and the server 150 may include a memory 221, processing circuitry (e.g., a processor 222), a communication module 223, and/or an I/O interface 224. The memory 211, 221 may include a permanent mass storage device, such as a random access memory (RAM), a read only memory (ROM), a disk drive, a solid state drive (SSD), a flash memory, etc., as a non-transitory computer-readable record medium. The permanent mass storage device, such as a ROM, an SSD, a flash memory, and/or a disk drive, may be included in the electronic device 110 and/or the server 150 as a permanent storage device separate from the memory 211, 221. Also, an OS and at least one program code, for example, a code for a browser installed and running on the electronic device 110 or an application installed and running on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. According to some example embodiments, the processor 212 and the processor 222 may each be implemented using a processor, or any other form of processing circuitry.

For example, the processor 212, 222 may be configured to process instructions of a computer program by performing basic arithmetic operations, logic operations, and/or I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170 and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interfacing with an I/O apparatus 215 (e.g., an input device and/or an output device). For example, an input device may include a device, such as a keyboard, a mouse, a microphone, a camera, etc., and an output device may include a device, such as a display, a speaker, a haptic feedback device, etc. As another example, the I/O interface 214 may be a device for interfacing with an apparatus in which an input function and an output function are integrated into a single function, such as a touchscreen. The I/O apparatus 215 may be configured as (e.g., incorporated in) a single device with the electronic device 110. Also, the I/O interface 224 of the server 150 may be a device for interfacing with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to some example embodiments, the electronic device 110 and/or the server 150 may include a number of components greater than or less than a number of components shown in FIG. 2. However, some components according to the related art are not illustrated in detail. For example, the electronic device 110 may include at least a portion of the I/O apparatus 215, or may further include other components, for example, a transceiver, a global positioning system (GPS) module, a camera, a variety of sensors, a database (DB), and/or the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, some example embodiments of a method and system for immediate or prompt trading of a cryptocurrency are described.

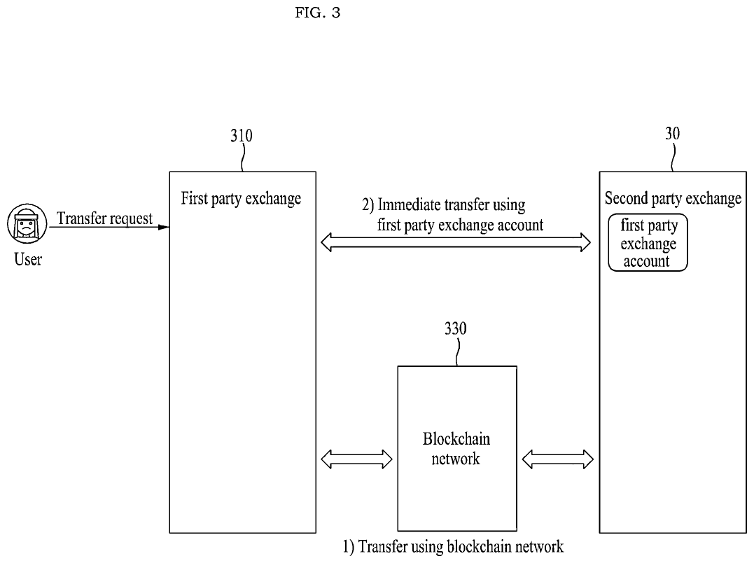

FIG. 3 illustrates an example of a process of processing a transfer transaction according to some example embodiments.

A cryptocurrency trading system 310 serves as a cryptocurrency exchange to provide a cryptocurrency trading service and may be implemented by the server 150 of FIGS. 1 and 2.

The term “user” used herein may represent a portion of a plurality of users using the cryptocurrency trading system 310, and may represent at least one of the plurality of electronic devices 110, 120, 130, and 140.

Also, the term “first party exchange” may represent the cryptocurrency currency system 310's own exchange and the term “second party exchange” may represent another exchange that is a target exchange.

FIG. 3 illustrates an example of a transfer from a first party exchange of the cryptocurrency trading system 310 to a second party exchange 30.

1) Trading Scheme Using a Blockchain Network:

In response to receiving a transfer request to the second party exchange 30 from a user using the first party exchange, the cryptocurrency trading system 310 proceeds with a transfer transaction to the second party exchange 30 through a blockchain network 330.

That is, the cryptocurrency trading system 310 creates a transaction in response to the transfer request to the second party exchange 30, applies a fee rate to the corresponding transaction, and then submits the transaction to the blockchain network 330. When the transaction submitted to the blockchain network 330 is discovered and mined by a miner, a cryptocurrency of a transfer request quantity is transferred on the blockchain network 330 and the transfer transaction is completed accordingly.

Here, in the case of the transaction through the blockchain network 330, a processing time of the transfer transaction is determined based on a situation of the blockchain network 330 or a fee rate applied to the corresponding transaction.

A trading scheme that involves creating a transaction for transfer corresponding to each request and using the blockchain network 330 may increase transaction priority by raising a fee amount. If mining is delayed due to a low fee rate or a network situation, a relatively long time may pass before the transfer transaction is completed.

2) Trading Scheme Using a First Party Exchange Account:

To outperform the issue found in the trading scheme using the blockchain network 330, the cryptocurrency trading system 310 may provide a cryptocurrency trading service in a structure that allows an immediate transfer. According to some example embodiments, an immediate transfer may be a transfer that is immediate or prompt.

In response to receiving a transfer request to the second party exchange 30 from the user using the first party exchange, the cryptocurrency trading system 310 may more rapidly process a transfer through an internal transaction using a first party exchange account opened on the second party exchange 30 instead of the transaction using the blockchain network 330.

The term “first party exchange account” used herein refers to a first party account of the cryptocurrency trading system 310 (the terms “first party exchange account” and “first party account” may be interchangeably used throughout) opened on another exchange, for example, the second party exchange 30, and may support an internal transaction on the second party exchange 30 through application programming interface (API) calling. That is, the first party exchange account may be opened on the second party exchange 30 to enable an internal transaction on the second party exchange 30, and may also correspond to the first party account of the cryptocurrency trading system 310 and deposit, withdrawal, and balance inquiry, etc., thereof may be manageable by the cryptocurrency trading system 310 accordingly.

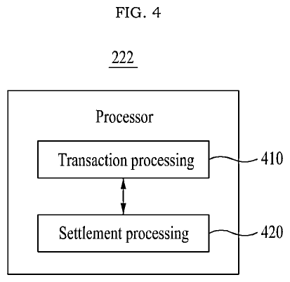

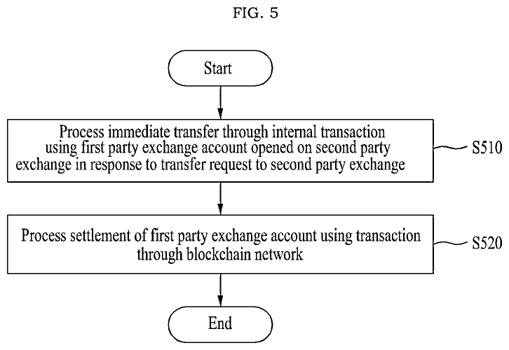

FIG. 4 is a diagram illustrating an example of components includable by a processor of a server according to some example embodiments, and FIG. 5 is a flowchart illustrating an example of a method performed by a server according to some example embodiments.

The server 150 according to some example embodiments may be implemented as the aforementioned cryptocurrency trading system 310. Here, the cryptocurrency trading system 310 serves as a platform that provides a cryptocurrency trading service, and, particularly, may provide the cryptocurrency trading service in a structure that allows an immediate transaction between cryptocurrency exchanges. According to some example embodiments, an immediate transaction may be a transaction that is immediate or prompt.

Referring to FIG. 4, to perform the cryptocurrency trading method of FIG. 5, the processor 222 of the server 150 may include a transaction processing 410 and/or a settlement processing 420. Depending on some example embodiments, the components of the processor 222 (e.g., the transaction processing 410 and/or the settlement processing 420) may be selectively included in or excluded from the processor 222. Also, depending on some example embodiments, the components of the processor 222 may be separated or merged for representations of functions of the processor 222. According to some example embodiments, the transaction processing 410 and/or the settlement processing 420 may be implemented using processing circuitry.

The processor 222, and/or the components of the processor 222, may control the server 150 to perform operations S510 and S520 included in a cryptocurrency trading method of FIG. 5. For example, the processor 222, and/or the components of the processor 222, may be configured to execute an instruction according to a code of at least one program and a code of an OS included in the memory 221.

Here, the components of the processor 222 may be representations of different functions performed by the processor 222 in response to an instruction provided from the program code stored in the server 150. For example, the transaction processing 410 may be used as a functional representation of the processor 222 that controls the server 150 to process a transfer transaction in response to the instruction.

The processor 222 may read an instruction from the memory 221 to which instructions associated with control of the server 150 are loaded. In this case, the read instruction may include an instruction for controlling the processor 222 to perform the following operations S510 and S520. The following operations S510 and S520 may be performed in order different from order illustrated in FIG. 5 and a portion of operations S510 and S520 may be omitted. Alternatively, an additional process may be further included.

Referring to FIG. 5, in operation S510, in the case of receiving a transfer request from a first party exchange provided by the cryptocurrency trading system 310 to a second party exchange, the transaction processing 410 may process an immediate transfer through an internal transaction using a first party exchange account opened on the second party exchange in response to the received transfer request. The transaction processing 410 may process the transfer transaction requested from the user through a trading scheme using the first party exchange account opened on the second party exchange instead of a trading scheme using the blockchain network 330. That is, the transaction processing 410 may process an immediate (or prompt) withdrawal using the first party exchange account that is a common account for a plurality of users using the first party exchange.

The cryptocurrency trading system 310 may provide a user interface for a transfer request and may receive information about the transfer request through the user interface. Here, the user interface may include an option for a trading scheme. The option for the trading scheme may include 1) the trading scheme using the blockchain network 330 and 2) the trading scheme using the first party exchange account. Depending on some example embodiments, when the first party exchange account is opened on another exchange, that is, a second party exchange to which the user desires to transfer an amount (e.g., an amount of cryptocurrency), the transaction processing 410 may include, in the user interface, an option input interface for an option for a trading scheme selectable from the user and may provide the user interface. The transaction processing 410 may process the transfer transaction (e.g., funds transfer) through one of 1) the trading scheme using the blockchain network 330 and/or 2) the trading scheme using the first party exchange account, according to a user selection input through the user interface.

In operation S520, the settlement processing 420 may process a settlement of the first party exchange account using the transaction through the blockchain network 330. The settlement processing 420 may process the transfer transaction in the first party exchange account on the second party exchange through the blockchain network 330 as a settlement according to the immediate transfer. According to some example embodiments, in operation S520 the settlement processing 420 may process the settlement of the first party exchange account as a settlement transaction through the blockchain network 330. The settlement transaction may settle the amount of the transfer transaction performed in operation S510. According to some example embodiments, the second party exchange may be implemented using the server 160.

Some example embodiments may support an immediate transaction through offset processing or an algorithm equivalent thereto, rather than a transaction through the blockchain network 330 between the first party exchange and the second party exchange. For the immediate transaction, the balance of the first party exchange account on the second party exchange may be maintained at a predetermined (or, alternatively, desired) level or more at all times. To this end, an amount to be deposited in the second party exchange may be calculated through a settlement and may be transferred to the first party exchange account on the second party exchange through the transaction scheme using the blockchain network 330.

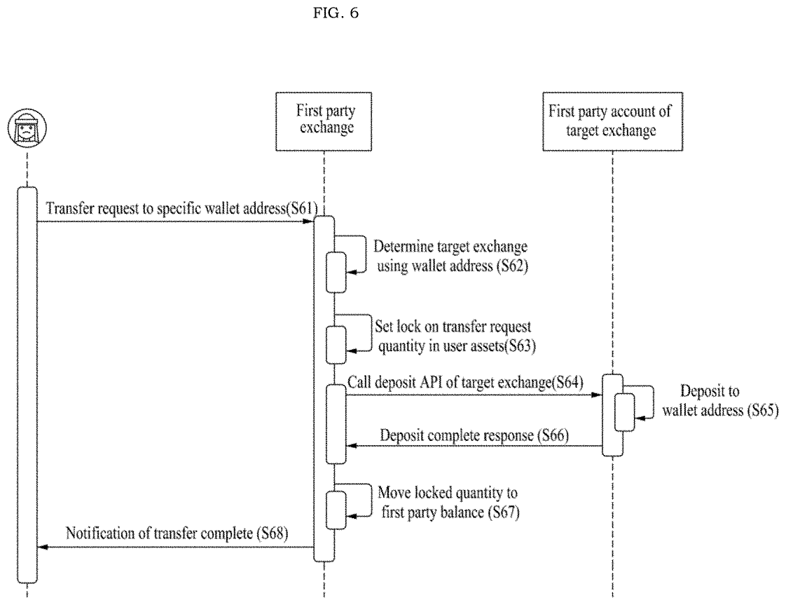

FIG. 6 is a flowchart illustrating an example of an immediate transfer process according to some example embodiments.

Referring to FIG. 6, in operation S61, the transaction processing 410 may receive a transfer request from a user, for example, using a first party exchange. The transfer request may include a specific wallet address (hereinafter, referred to as a recipient wallet address) to which the user desires to transfer an amount and/or a cryptocurrency quantity. A wallet address may identify an account on an exchange, and may be created and managed by an exchange. The user may request a transaction (e.g., a transfer transaction) such as a transfer (e.g., funds transfer) using the wallet address. According to some example embodiments, the user may input the transfer request into the electronic device 110 and the electronic device 110 may provide the transfer request to the first party exchange.

In operation S62, the transaction processing 410 may determine a target exchange to which the user desires to transfer an amount using the recipient wallet address. That is, the transaction processing 410 may recognize the transfer request to the second party exchange (e.g., the server 160) by verifying the target exchange corresponding to the recipient wallet address. According to some example embodiments, the recipient wallet address may include information (e.g., a value, format, etc.) that identifies the exchange to which the recipient wallet address corresponds, and the transaction processing 410 may identify the second party exchange using the recipient wallet address based on this information.

In operation S63, the transaction processing 410 may set a lock on a transfer request quantity in cryptocurrency assets held by the user on the first party exchange. As another example, the transaction processing 410 may set a lock on a quantity that is obtained by adding a predetermined (or, alternatively, desired) quantity or amount to the transfer request quantity, or a quantity that is obtained by adding a predetermined (or, alternatively, desired) ratio to the transfer request quantity (e.g., transfer request quantity+α), in the cryptocurrency assets held by the user on the first party exchange. The transaction processing 410 may first set a lock on the transfer request quantity in assets of the user immediately (or promptly) after confirming the target exchange or immediately (or promptly) after receiving the transfer request.

In operation S64, the transaction processing 410 may call a deposit API of the target exchange. That is, the transaction processing 410 may call the deposit API, for deposit from the first party exchange account on the target exchange, to the recipient wallet address.

In operation S65, the transaction processing 410 may deposit the quantity requested by the user, to be transferred to the recipient wallet address, according to calling of the deposit API. The transaction processing 410 may provide a rapid transfer by immediately (or promptly) applying, to the recipient wallet address, the quantity requested by the user to be transferred through an internal transaction using the first party exchange account on the target exchange (e.g., the server 160). According to some example embodiments, the first party exchange account is an account established by (or for) the first party exchange on the target exchange. According to some example embodiments, the first party exchange account includes funds (e.g., cryptocurrency) of the first party exchange for use in performing immediate transfers.

In operation S66, as the deposit from the first party exchange account to the recipient wallet address is processed, the transaction processing 410 may verify a deposit complete response (e.g., from the deposit API).

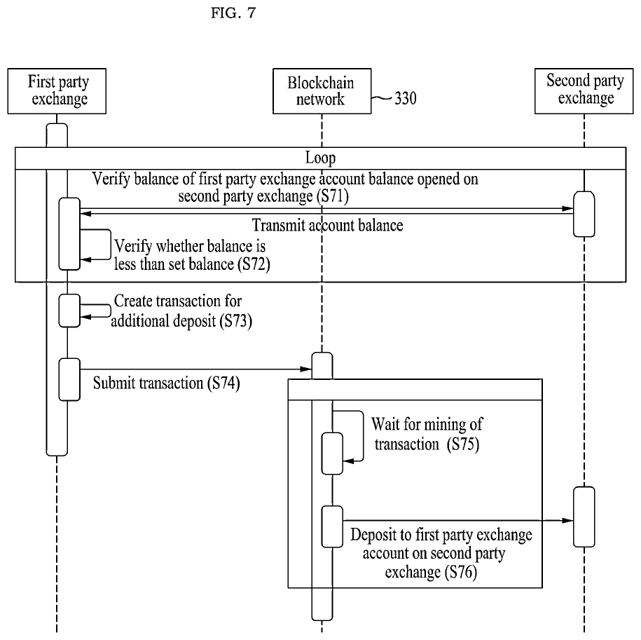

In operation S67, once the deposit to the recipient wallet address is completed, the transaction processing 410 may move at least a portion of the locked quantity from the user assets on the first party exchange to a first party exchange balance. The transaction processing 410 may apply the locked quantity in the user assets to a first party balance (e.g., after pre-deposit processing) from the first party exchange account to the recipient wallet address without using the blockchain network 330. Here, if a lock is set on a quantity that is obtained by adding a predetermined (or, alternatively, desired) quantity or amount to the transfer request quantity, or a quantity that is obtained by adding a predetermined (or, alternatively, desired) ratio to the transfer request quantity (e.g., transfer request quantity+α), the transaction processing 410 may apply a quantity less than the locked quantity and greater than or equal to the transfer request quantity in the user assets to the first party balance. According to some example embodiments, the transaction processing 410 may move a portion of the user assets equal or similar to the amount of the transfer transaction from a user account at the first exchange to an exchange account at the first exchange, thus compensating the first exchange for the deposit transaction performed at the target exchange. According to some example embodiments, this portion of the user assets corresponding to the transfer function may be transferred to the first party exchange account on the target exchange in a settlement process discussed further below in connection with FIG. 7.

In operation S68, when the deposit to the recipient wallet address and applying the same to the first party balance are all completed, the transaction processing 410 provides a notification indicating that a transfer (e.g., a withdrawal) is completed to the user that has requested the transfer.

Therefore, in response to the transfer request from the first party exchange to the second party exchange, the transaction processing 410 may support the transfer from the first party exchange account on the second party exchange to the recipient wallet address, that is, the immediate transfer through the internal transaction on the second party exchange, instead of the transaction using the blockchain network 330.

FIG. 7 is a flowchart illustrating an example of a settlement process according to an immediate transfer according to some example embodiments.

Referring to FIG. 7, in operation S71, the settlement processing 420 periodically verifies a balance of a first party exchange account opened on a second party exchange. For an immediate transaction, the balance of the first party exchange account on the second party exchange should be maintained at a predetermined (or, alternatively, desired) level or more at all times. Therefore, it is desirable to periodically check the balance.

In operation S72, the settlement processing 420 determines whether to make an additional deposit according to the balance of the first party exchange account through balance checking. When the balance of the first party exchange account is less than a set balance, the settlement processing 420 enters an additional deposit process. Here, the set balance may be determined based on statistical information of transactions related to the first party exchange account for a recent predetermined (or, alternatively, desired) period. Here, the statistical information may be an average transaction amount related to the first party exchange account for the recent predetermined (or, alternatively, desired) period or transaction trend for a predetermined (or, alternatively, desired) period. For example, the set balance may be determined based on trading volume using the first party exchange account for the recent predetermined (or, alternatively, desired) period. According to an increase in the recent trading volume, the set balance may be determined to be higher. As another example, an exchange-by-exchange deposit balance opened on the second party exchange may be collected and the average balance may be used as the set balance.

In operation S73, the settlement processing 420 may create a transaction for withdrawal of a quantity for the additional deposit. For example, the additional deposit quantity (also referred to herein as a deposit quantity) may be determined based on a difference amount between the current balance and the set balance. As another example, the additional deposit quantity may be determined based on a trading balance using the first party exchange account for the recent predetermined (or, alternatively, desired) period. According to an increase in the recent trading volume, the additional deposit quantity may be determined to be higher. According to some example embodiments, the additional deposit quantity may include an amount (e.g., cryptocurrency amount) corresponding to the transfer transaction discussed in association with FIG. 6.

In operation S74, the settlement processing 420 applies a fee rate to the transaction for the additional deposit and submits the transaction with the applied fee rate to the blockchain network 330. The term “transaction fee” refers to price paid to a miner that serves to perform a transaction in a blockchain and to create and store a transaction history block, and may be determined based on a transaction scale and a fee rate.

In operation S75, the settlement processing 420 waits for mining by a miner for the transaction submitted to the blockchain network 330. Mining for the transaction on the blockchain network 330 may be performed by the miner (e.g., the electronic device 120).

When the transaction submitted to the blockchain network 330 is mined by the miner, the additional deposit quantity according to the corresponding transaction may be deposited to the first party exchange account on the second party exchange in operation S76.

Therefore, when the additional deposit is to be made due to settlement according to the immediate transfer, the settlement processing 420 may perform a transfer from the first party balance on the first party exchange to the first party exchange account on the second party exchange using a transaction through the blockchain network 330.

As described above, according to some example embodiments, a processing time of a cryptocurrency trading may be significantly reduced by providing an immediate transfer through an internal transaction, using a first party exchange account opened on a second party exchange instead of a transaction using a blockchain network, in response to a transfer request to the second party exchange.

For example, conventional devices for cryptocurrency trading process transfer transactions (e.g., funds transfers) between exchanges through a blockchain network. However, processing such a transaction in a blockchain network involves discovery and mining of the transaction by a miner. Accordingly, the conventional devices for cryptocurrency trading experience excessive delay in processing transfer transactions between exchanges.

However, according to some example embodiments, improved devices for cryptocurrency trading are provided. For example, the improved devices process transfer transactions (e.g., funds transfers) between two exchanges as an internal transaction, using a first party exchange account opened on the second party exchange, without using the blockchain network. Subsequently, a settlement transaction is performed between the two exchanges that is processed through the blockchain network. However, processing the settlement transaction through the blockchain network does not delay the processing of the transfer transactions. Accordingly, the improved devices for cryptocurrency trading overcome the deficiencies of the conventional devices to at least reduce transfer transaction processing delay.

The systems and/or apparatuses described above may be implemented using hardware components, software components, and/or a combination thereof. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The above-described methods according to some example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes some example embodiments, it will be apparent to one of ordinary skill in the art that various alterations and modifications in form and details may be made without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A cryptocurrency trading method performed by a computer system, the computer system including at least one processor configured to execute computer-readable instructions stored in a memory, the cryptocurrency trading method comprising:
receiving, by the at least one processor, a transfer request from a user for a transfer transaction to a second party exchange from a first party exchange, the first party exchange being provided by the computer system; and
processing, by the at least one processor, the transfer transaction as an internal transaction in response to the transfer request by using a first party account without using a blockchain network, the first party account being an account of the first party exchange on the second party exchange.

2. The cryptocurrency trading method of claim 1, wherein the processing of the transfer transaction comprises:
calling a deposit application programming interface (API) for deposit from the first party account to a recipient wallet address, the recipient wallet address being included in the transfer request.

3. The cryptocurrency trading method of claim 1, wherein the processing of the transfer transaction comprises:
setting a lock on a transfer request quantity of assets of the user on the first party exchange, the transfer request quantity being included in the transfer request;
performing deposit processing by applying the transfer request quantity from the first party account to a recipient wallet address, the recipient wallet address being included in the transfer request; and
moving the locked quantity to a first party balance on the first party exchange.

4. The cryptocurrency trading method of claim 2, wherein the processing of the transfer transaction further comprises:
determining a target exchange corresponding to the second party exchange using the recipient wallet address.

5. The cryptocurrency trading method of claim 1, wherein the processing of the transfer transaction comprises:
providing the user with a user interface after the first party account is opened on the second party exchange, the user interface enabling selection of a trading scheme option among a plurality of trading scheme options, the plurality of trading scheme options include a first trading scheme using the blockchain network and a second trading scheme using the first party account; and
processing the transfer transaction using the first party account based on a selection by the user of the second trading scheme.

6. The cryptocurrency trading method of claim 1, further comprising:
processing, by the at least one processor, a settlement of the first party account using a settlement transaction through the blockchain network, the settlement corresponding to the transfer transaction.

7. The cryptocurrency trading method of claim 6, wherein the processing of the settlement of the first party account comprises:
creating the settlement transaction for withdrawal of a deposit quantity; and
submitting the settlement transaction to the blockchain network based on a current balance of the first party account being less than a first balance, and the deposit quantity being deposited to the first party account after the settlement transaction is mined by the blockchain network.

8. The cryptocurrency trading method of claim 7, wherein the first balance is determined based on a trading volume using the first party account for a period.

9. The cryptocurrency trading method of claim 7, wherein the first balance is determined based on an average exchange-by-exchange deposit balance opened on the second party exchange.

10. The cryptocurrency trading method of claim 7, wherein the deposit quantity is determined based on a trading volume using the first party account for a period.

11. The cryptocurrency trading method of claim 7, wherein the deposit quantity is determined based on a difference amount between the current balance and the first balance.

12. A non-transitory computer-readable record medium storing instructions that, when executed by at least one processor included in a computer system, cause the computer system to perform the cryptocurrency trading method of FIG. 1.

13. A computer system comprising:
at least one processor configured to execute computer-readable instructions stored in a memory to
process a transfer transaction through an internal transaction using a first party account instead of a transaction using a blockchain network in response to a transfer request, the first party account being an account of a first party exchange on a second party exchange, the transfer request being received from a user for the transfer transaction to the second party exchange from the first party exchange, and the first party exchange being provide by the computer system.

14. The computer system of claim 13, wherein the at least one processor is configured to execute the computer-readable instructions to call a deposit application programming interface (API) for deposit from the first party account to a recipient wallet address, the recipient wallet address being included in the transfer request.

15. The computer system of claim 13, wherein the at least one processor is configured to execute the computer-readable instructions to:
set a lock on a transfer request quantity of assets of the user on the first party exchange, the transfer request quantity being include in the transfer request;
perform deposit processing by applying the transfer request quantity from the first party account to a recipient wallet address, the recipient wallet address being included in the transfer request; and
move the locked quantity to a first party balance on the first party exchange.

16. The computer system of claim 14, wherein the at least one processor is configured to execute the computer-readable instructions to determine a target exchange corresponding to the second party exchange using the recipient wallet address.

17. The computer system of claim 13, wherein the at least one processor is configured to execute the computer-readable instructions to:
provide the user with a user interface after the first party account is opened on the second party exchange, the user interface enabling selection of a trading scheme option among a plurality of trading scheme options, the plurality of trading scheme options include a first trading scheme using the blockchain network and a second trading scheme using the first party account; and
process the transfer transaction using the first party account based on a selection by the user of the second trading scheme.

18. The computer system of claim 13, wherein the at least one processor is configured to execute the computer-readable instructions to process a settlement of the first party account using a settlement transaction through the blockchain network, the settlement corresponding to the transfer transaction.

19. The computer system of claim 18, wherein the at least one processor is configured to execute the computer-readable instructions to:
create the settlement transaction for withdrawal of a deposit quantity; and
submit the created settlement transaction to the blockchain network based on a current balance of the first party account being less than a first balance, and the deposit quantity being deposited to the first party account after the settlement transaction is mined by the blockchain network.

20. The computer system of claim 19, wherein the deposit quantity is determined based on a trading volume using the first party account for a period.
